(19) United States
(12) Patent Application Publication
(10) Pub. No.: US 2008/0205109 A1
(43) Pub. Date: Aug. 28, 2008

(54) ENERGY DISTRIBUTION SYSTEM FOR VEHICLE

(75) Inventors: Yann Darroman, Barcelona (ES); Ignacio Alvarez-Troncosco, Valls Tarragona (ES)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/678,638

(22) Filed: Feb. 26, 2007

(51) Int. Cl. H02M 7/5387; H02M 7/537

(52) U.S. Cl. 363/132; 363/131

(57) ABSTRACT

An electric power distribution system configured to facilitate transferring energy between an energy source and load. The distribution system may be configured or otherwise adapted to invert DC energy to AC energy when driving the load and to invert AC energy to DC energy when regenerating the energy source.

### BACKGROUND OF THE INVENTION

1. Field of the Invention

The present invention relates to an energy distribution system suitable for use with a vehicle, such as but not limited to an electrically drivable vehicle.

2. Background Art

Hybrid electric vehicles (HEVs) and electric vehicles (EVs) include capabilities to drive vehicles partially and/or completely as a function of electric energy. Typically, electric energy is provided from a high voltage source to a motor or other electrically operable element to actuate the motor in such a manner as to drive or otherwise move the vehicle.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates an electric drive system in accordance with one non-limiting aspect of the present invention;

FIG. 2 illustrates features of the power distribution system in accordance with one non-limiting aspect of the present invention;

FIG. 3 illustrate an inverter and converter in accordance with one non-limiting aspect of the present invention; and

FIGS. 4-6 illustrate additional inverters and converter in accordance with one non-limiting aspect of the present invention.

### DETAILED DESCRIPTION OF THE PREFERRED EMBODIMENT(S)

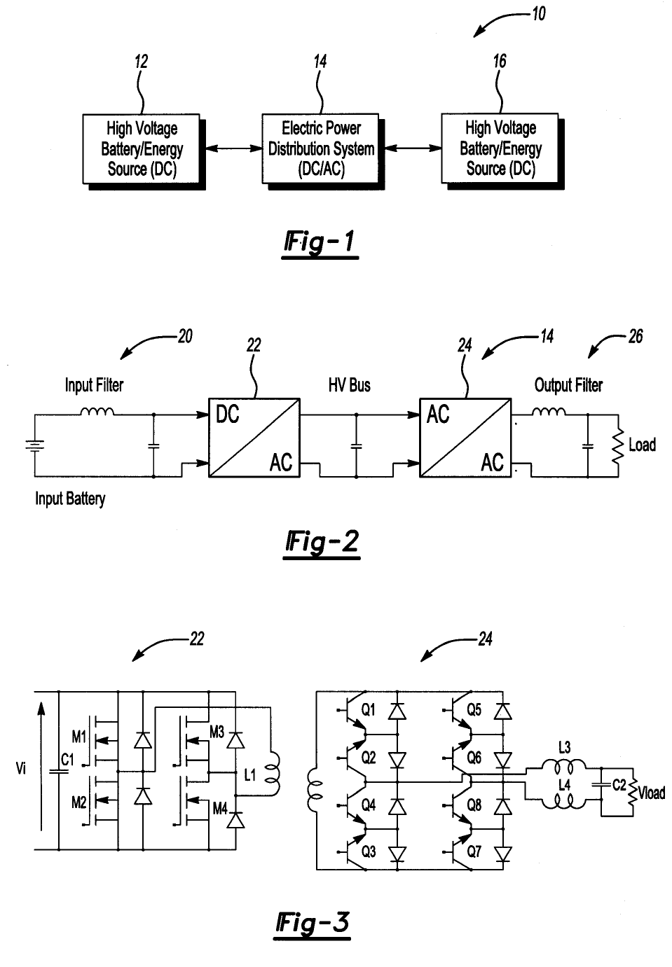

FIG. 1 illustrates an electric drive system 10 in accordance with one non-limiting aspect of the present invention. The drive system 10 may be configured or otherwise adapted for use in HEVs or EVs to support electric based operations, such as but not limited to operations associated with driving an electric motor or load. The system generally includes a high voltage battery/energy source 12 for providing high voltage energy to an electric load 16 associated with the vehicle.

For exemplary purposes, and without intending to limit the scope and contemplation of the present invention, the load 16 is most predominately described with respect to being an electric motor suitable for driving the vehicle. The present invention, however, is not intended to be so limited and fully contemplates the load 16 being an AC power device, whether included on the vehicle and/or otherwise connected thereto.

An electric power distribution system 14 may be included to facilitate transferring energy between the energy source 12 and load 16, and optionally other devices and networks connected thereto. The distribution system 14 may be configured or otherwise adapted to invert DC energy to AC energy when driving the load and to invert AC energy to DC energy when regenerating the battery. In this manner, the power distribution system 14 may act as a bi-direction inverter capable of inverting relative high voltages, such as to facilitate charging the energy source from a domestic wall outlet or other power source.

FIG. 2 illustrates features of the power distribution system 14 in accordance with one non-limiting aspect of the present invention. The features may include an input filter 20, a DC/AC inverter 22, a AC/AC converter 24, and an output filter 26. The filters may be configured to filter noise and other variables from the transferred energy. The inverter 22 and converter 24 may be configured and correspondingly controlled with a controller or other feature (not shown) to facilitate the desired inversion process, i.e. inverting energy to facilitate powering the AC load and/or to facilitate charging the battery.

The combination of the DC/AC inverter 22 and the AC/AC converter 24 is believed to be an efficient way to obtain a low total harmonic threshold (THD) high voltage AC output relative to systems relying on a DC/DC connected to a DC/AC converter. The output filter for a DC/DC DC/AC stage inverter tends to be bulky since the power factor correction is made with passive components which are principally chokes and power capacitors. The power factor correction when using the AC/AC converter of the present invention may be made in an active way, reducing the size, weight and cost of the output filter components.

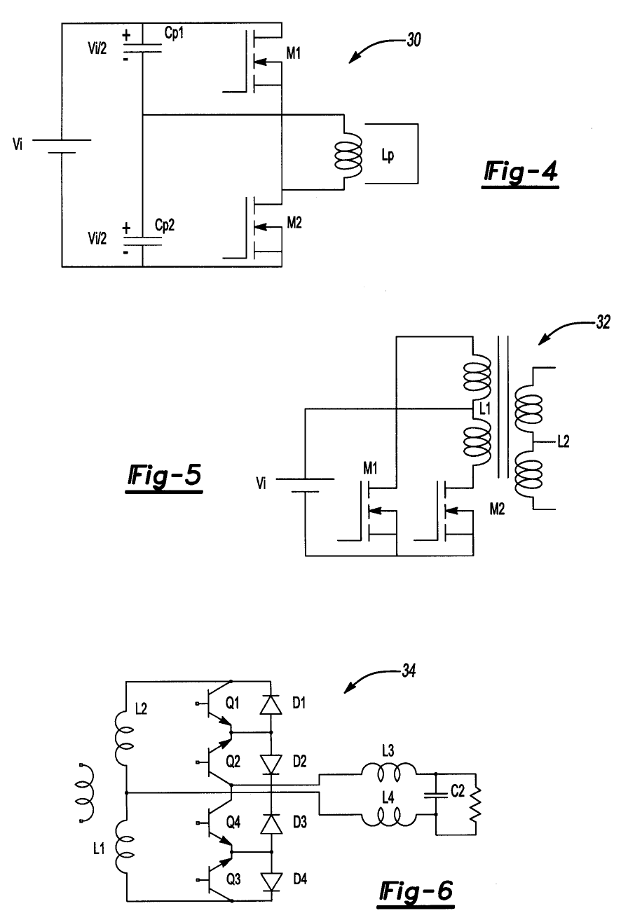

FIG. 3 illustrate the inverter 22 and converter 24 in accordance with one non-limiting aspect of the present invention. The inverter 22 and converter 24 may be connected to each other so as to provide an integrated structure. The inverter 22 may be constructed as a full bridge inverter and the converter 24 may be constructed as a full bridge converter. These particular configurations of the inverter 22 and converter 24 are believed to provide superior performance over other arrangements, such a half bridge converter 30 (FIG. 4), push-pull inverter 32 (FIG. 5), half-bridge inverter 34 (FIG. 6). However, the present invention is not intended to be so limited and fully contemplates the use of any one of these other configurations.

Regarding the half bridge inverter (FIG. 4), although the design requires only two power MOSFETs (M1 and M2), two extra power capacitors (Cp1 and Cp2) are required compared to the full bridge converter. Moreover, since the solicitation in current is higher, the MOSFETS and transformer must be oversized relative to the smaller corresponding features of the half bridge inverter. These differences increase the size, weight and cost of the system. Also, the power MOSFET dissipates more power than that of the full-bridge converter since the current stress is higher in the MOSFET. The latter increases the losses in the semiconductor and creates hot spots, which are very difficult to manage and hence, make the cold-plate required more expensive and difficult to design to evacuate this power loss. This cost increase is further emphasized due to the fact that the semiconductor must withstand twice the input current of the DC/AC inverter, which may lead to the use of unusual and expensive power MOSFETs.

The push-pull inverter (FIG. 5) is less suitable than the half-bridge inverter since the semiconductor must withstand twice the output current of the DC/AC inverter, which may lead to the use of unusual and expensive power MOSFETs (M1 and M2). Moreover, due to the tapping of the primary transformer, there is a peak of current/voltage produced across the primary power MOSFET (M1) due to the leakage inductor of the primary winding. Therefore to combat this voltage peak, a snubber may be required, making the design more complex, bigger, heavier and more expensive because of the presence of the snubber.

The full bridge inverter (FIG. 3) 22 arrangement of one aspect of the present invention is thus selected as a solution because it uses standard power MOSFETs (M1-M4) and because it uses untapped primary winding (L1) and no snubber. Furthermore, the use of 4 switches of the present invention can be defrayed since the full bridge can be used as ZVT (zero voltage transition), whereby the switching of the power MOSFETs (M1-M4) is done when the voltage across the switches is 0, minimizing the losses. This function is not feasible with the half bridge and push pull since only 2 power switches are used.

Turning to the converters, the half bridge DC/AC converter (FIG. 6), for uni-directional operation, may be made of two switches (Q1, Q4) and two diodes (D1, D3). If a bi-directional inverter/battery charger is required, then two top switches (Q1, Q2) and two top diodes (D1, D2) and two bottom switches (Q3, Q4) and two bottom diodes (D3, D4) may be used.

The power distribution system 14 depicted in FIGS. 2-3 is made of a DC/AC inverter 22 and AC/AC converter 24. The DC/AC phase may be configured as a full bridge inverter made of four power Mosfets (M1-M4) with four diodes (D1-D4) in parallel with each of them. The uni-directional full bridge AC/AC converter may be made of one top right and left switches (Q1, Q5) and one top left and right diode (D1, D5) and one bottom left and right switch (Q3, Q7) and one left and right bottom diode (D3, D7). If a bi-directional inverter/battery charger is required, then two top left and right switches (Q1, Q2, Q5, Q6) and two top left and right diodes (D1, D2, D5, D6) and two left and right bottom switches (Q3, Q4, Q7, Q8) and two left and right bottom diodes (D3, D4, D7, D8) may be used. The converter may include a common mode filter at the output made of two inductor (L3 and L4) which can be coupled or not and of a capacitor C2 in parallel with the load.

Compared to the full bridge DC/AC converter, the half bridge converter may require a tapped-secondary winding, making its configuration more complex to manufacture and creating a leakage inductor. To minimize the notorious effect of the leakage inductor in the DC/AC design, a complex, planar transformer may have to be used together with a snubber to minimize the spikes across the Power IGBTs. Also, the cost increase may be further emphasized due to the fact that the semiconductor must withstand twice the input current of the DC/AC inverter, which may lead to the use of unusual and expensive power Mosfets.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An electrical distribution system for inverting energy transferred between a vehicle battery and a vehicle load, the system comprising:
a DC/AC inverter in electrical communication with the battery, the inverter configured for inverter DC energy to AC energy; and
a AC/AC converter in electrical communication with the inverter and vehicle load, the converter configured to converter the AC energy output from the inverter for output to the vehicle load.

2. The system of claim 1 wherein the inverter is directly connected to the converter.

3. The system of claim 1 wherein the inverter is a full bridge inverter.

4. The system of claim 3 wherein the full bridge inverter includes four switches.

5. The system of claim 1 wherein the converter is a full bridge converter.

6. The system of claim 5 wherein the full bridge converter includes two switches to facilitate uni-directional operation.

7. The system of claim 5 wherein the full bridge converter includes four switches to facilitate bi-directional operation.

8. The system of claim 1 wherein the converter is a full bridge converter and the inverter is a full bridge inverter.

9. The system of claim 1 wherein the vehicle load is an electric motor configured to drive the vehicle as a function of the AC energy output of the converter.

10. The system of claim 9 wherein the motor, converter, and inverter are bi-direction so as to facilitate charging the battery with energy from the motor.

11. The system of claim 1 wherein the load is connected to the converter by way of a plug included on the vehicle, the load being separate from the vehicle.

12. The system of claim 1 wherein the converter and inverter are bi-direction so as to facilitate charging the battery with energy from a domestic wall outlet connect to a vehicle plug.

13. The system of claim 1 further comprising an input filter for filtering the DC energy and an output filter for filtering the AC energy outputted from the converter.

14. The system of claim 1 further comprising a common mode output filter connected between the converter and the vehicle load.

15. The system of claim 14 wherein a common mode filter is connected between the vehicle batter and inverter.

16. The system of claim 15 wherein the filters, inverter, and converter are included with a junction box.

17. An electrical distribution system for inverting energy transferred between a vehicle battery and a vehicle load, the system comprising:
a full bridge DC/AC inverter in electrical communication with the battery, the inverter configured for inverter DC energy to AC energy; and
a full bridge AC/AC converter in electrical communication with the inverter and vehicle load, the converter configured to converter the AC energy output from the inverter for output to the vehicle load.

18. An electrical distribution system for inverting energy transferred between a vehicle battery and a vehicle load, the system comprising:
a DC/AC inverter in electrical communication with the battery, the inverter configured for inverter DC energy to AC energy;
a AC/AC converter in electrical communication with the inverter and vehicle load, the converter configured to converter the AC energy output from the inverter for output to the vehicle load; and
wherein the converter and inverter are bi-direction so as to facilitate charging the battery with energy from a domestic wall outlet connect to a vehicle plug and with energy from an electric motor used to drive the vehicle.

19. The system of claim 18 wherein the inverter is a full bridge inverter.

20. The system of claim 18 wherein the inverter is a full bridge inverter.
